(19) United States
(12) Patent Application Publication
(10) Pub. No.: US 2014/0099204 A1
(43) Pub. Date: Apr. 10, 2014

(54) BRAKING DEVICES FOR VERTICAL AXIS WIND TURBINES

(71) Applicant: Yves Debleser, Naast (BE)

(72) Inventor: Yves Debleser, Naast (BE)

(21) Appl. No.: 14/105,585

(22) Filed: Dec. 13, 2013

Related U.S. Application Data
(63) Continuation of application No. PCT/EP2012/061363, filed on Jun. 14, 2012.

(30) Foreign Application Priority Data
Jun. 15, 2011 (BE) 2011/0360

(51) Int. Cl. F03D 7/06

(52) U.S. Cl. CPC F03D 7/06
USPC 416/23

(57) ABSTRACT

Braking devices for wind turbines having a vertical axis are disclosed. An example braking device includes a flap able to tip about a tipping axis. The example flap has a center of gravity positioned outside the tipping axis. In addition, the example braking device disclosed herein includes a torque limiter having a disengagement torque. In addition, the example flap is mounted on the torque limiter, and the torque limiter is to allow the flap to tip through a tipping angle about the tipping axis for a rotational speed of the flap about the vertical axis which induces a torque at the torque limiter greater than or equal to the disengagement torque.

### RELATED APPLICATIONS

This patent is a continuation of International Patent Application Serial No. PCT/EP2012/061363, filed on Jun. 14, 2012, which claims priority to Belgian Patent Application 2011/0360, filed on Jun. 15, 2011, both of which are hereby incorporated herein by reference in their entireties.

### TECHNICAL FIELD

This disclosure relates generally to wind turbines and, more specifically, to braking devices for vertical axis wind turbines.

### BACKGROUND

Wind turbines fall into two large categories: horizontal axis wind turbines and vertical axis wind turbines. Vertical axis wind turbines have certain advantages with respect to horizontal axis wind turbines: for example, their efficiency is not very dependent on wind direction. Vertical axis wind turbines are split into two categories: Savonius (differential drag) turbines and Darrieus turbines. In the case of Darrieus turbines, a driving torque that can be used to drive a rotor of an electricity generator results from the variation in angle of attack, and thus the lift acting on a blade of such a wind turbine, during a full revolution of the blade about the vertical axis of the wind turbine.

In order to protect a wind turbine from breaking in high winds, it is necessary to provide systems for reducing or limiting the rotational speed of the blades, or even halting this rotation completely. European Patent EP1857671 proposes small air brakes, mounted close to the trailing edge of the blades so as to limit the rotational speed of the blades of a Darrieus type vertical axis wind turbine. These air brakes can be activated by centrifugal force. Such devices are not very reliable as these air brakes may not engage, particularly in severe icing conditions. As such air brakes are lightweight, the centrifugal force acting on them is in fact not very large and can be less than the force that would prevent the air brakes pivoting, for example as a consequence of icing. U.S. Pat. No. 4,456,429 describes another speed control mechanism for a Darrieus type vertical axis wind turbine. The blades of such a wind turbine are connected to a vertical axis via horizontal arms (or bars) (reference 17 of FIG. 1 of this patent). An articulation mechanism (typically a hinge) connects the blades and these non-vertical arms. When the rotational speed of the blades about the vertical axis increases, they can pivot from a nominal position (in which the blades are perpendicular to their respective arms) toward a position in which they produce increased drag, thus reducing and/or limiting their rotational speed about the vertical axis. Springs return the blades to their nominal position when the rotational speed of the blades decreases.

The systems as described in patent U.S. Pat. No. 4,456,429 have certain drawbacks. Given the presence and the type of articulation mechanism connecting the blades to the horizontal arms, it is possible for the blades, after having undergone a sudden deflection with respect to these horizontal arms caused, for example, by a rapid change in wind speed, to flap with respect to these horizontal arms. It follows that the wind turbine then becomes unstable and that the blades can continue to rotate about the vertical axis despite a strong wind while pivoting with respect to the horizontal arms. The resultant instability of the wind turbine can induce large mechanical stresses in the elements of the wind turbine which is then at risk of breaking.

### SUMMARY

Disclosed herein are braking devices and systems for vertical axis wind turbines that are more effective and more stable than known systems. An example in accordance with the teachings of this disclosure includes a braking device for a wind turbine having a vertical axis and comprising a flap. The example flap is mechanically connected by a non-vertical arm to a vertical rotating shaft having an axis of rotation which coincides with said vertical axis. In addition, the example flap is designed to rotate about said vertical axis in a nominal position and to tip about a non-horizontal tipping axis. Also, the example flap has a center of gravity positioned outside the tipping axis. The nominal position being such that a centrifugal force induced by the rotation of said flap about said vertical axis and acting at said center of gravity is able to create a non-zero torque with respect to said tipping axis in this nominal position. In some examples disclosed herein, the braking device further comprises a torque limiter having a disengagement torque, one stationary portion and one portion that moves with respect to the non-vertical arm. In addition, the flap is mechanically connected to said moving portion of said torque limiter. Also, the moving portion of the torque limiter is able to allow the flap to tip from the nominal position through a tipping angle about the tipping axis when a threshold such as, for example, a maximum, rotational speed of the flap about the vertical axis is reached. A centrifugal force acting at the center of gravity of the flap in the nominal position then induces a torque at the torque limiter, which is greater than the disengagement torque.

A torque limiter is known to those skilled in the art. Once the torque limiter has disengaged, the example flap remains in a tipped position imposed by the torque limiter. The tipped position corresponds to the position of the flap once it has tipped from its nominal position. It is therefore impossible for the flap to pivot about the tipping axis subsequently, that is once the torque limiter has disengaged.

The example braking system disclosed herein is, thus, more stable. By virtue of this torque limiter, there is no need for additional damping systems to mitigate possible flapping of the blades. As the flap is locked in a given tipped position once the maximum rotational speed is reached, the additional drag imposed by this new position of the flap (the tipped position) is constant. The example system disclosed herein is, thus, more effective. It can also be used for emergency braking, which is useful in certain extreme conditions. Contrary to the device described in U.S. Pat. No. 4,456,429, once tipped, the flap does not return on its own to its nominal operating position when the rotational speed of the wind turbine decreases following the tipping of the flap into the tipped position. The torque limiter holds the flap in the position that corresponds to an increase in drag (tipped position). The example torque limiter disclosed herein is, thus, also able to hold the flap in the tipped position for a rotational speed of said flap about the vertical axis, lower than the maximum rotational speed (speed at which the flap tips into the tipped position from its nominal position). The example torque limiter disclosed herein does not operate simply as a hinge, that is merely a guiding member for a movement in rotation. The torque limiter allows the flap to tip but also controls the disengagement via its disengagement torque, that is the threshold for the force to be provided to cause the flap to tip. The example torque limiter disclosed herein also allows the flap to tip in a predetermined, amplitude-controlled manner (360°, 180°, 90° for example).

The example braking device disclosed herein has other advantages. When a maximum rotational speed is reached, the example braking device produces a sudden tipping of the flap about the tipping axis as a consequence of the torque exerted on the torque limiter by the centrifugal force acting at the center of gravity of the flap. This torque limiter disengages and, thus, allows a sudden tipping of the flap only when a torque at said limiter is greater than or equal to the disengagement torque. The distance between the center of gravity of the flap and the tipping axis represents a lever arm. The fact that the torque limiter disengages only at a predetermined torque value makes it possible to have a braking device which is more reliable with respect to the devices such as described in U.S. Pat. No. 4,456,429 where a simple articulation mechanism is used. Moreover, a progressive deflection of the blades with respect to their nominal position leads to a progressive increase in the drag that they induce, and thus, a reduction in the performance of the associated wind turbine, even if a maximum rotational speed is not reached. This is not the case for the example braking device disclosed herein, which alters the aerodynamic performance of the associated wind turbine only once a maximum wind speed is reached. The example braking device disclosed herein is triggered solely by a centrifugal force induced by the rotation of the blades about the vertical axis. No hydraulic, electronic, and/or mechanical control device is necessary to control the disengagement of the braking device or to cause the flap to tip into the tipped position. Thus, it is not necessary, for example, to provide cables or rods by means of which to cause the flap of the braking device to tip. A reliable and autonomous braking device is thus possible. The example braking device disclosed herein is also cost-effective. If the wind turbine to which the example braking device is associated comprises three blades, three flaps can be placed thereon. Thus, by virtue of the redundant three-flap arrangement, the reliability of the braking device is further increased.

The example braking device is further beneficial in that the maximum rotational speed of the blades about the vertical axis of a vertical axis wind turbine is limited, and therefore, the stresses to which the blades are exposed are also limited. The blades can be made of a wide range of materials when a limit value for the rotation is chosen in an adequate manner. The example braking device disclosed herein can typically be used for wind turbines of the Darrieus type having straight vertical blades, sometimes called H-rotor Darrieus turbines.

In some examples, the tipping axis is parallel to the vertical axis.

Also, in some examples, the vertical axis wind turbine comprises at least one blade mechanically connected to the vertical rotating shaft by the non-vertical arm, and the flap is a portion of the at least one blade. The flap of the example braking device disclosed herein is typically heavier than the air brakes described in European Patent EP1857671, allowing it to tip even in intense icing and/or freezing conditions. Moreover, the ice which could form on the flap would increase its weight, leading to earlier disengagement of the flap. In some examples disclosed herein, the portion of the at least one blade is mechanically connected to the moving portion of said torque limiter at one end of said at least one blade. Also, in some examples, the end corresponds to a lower end of said at least one blade.

In another example disclosed herein, the vertical axis wind turbine comprises at least one blade mechanically connected to the vertical rotating shaft by the non-vertical arm and the flap is one of said at least one blade.

In some examples, the tipping angle is about 90°.

Also, in some examples, the vertical axis wind turbine comprises at least one blade mechanically connected to the vertical rotating shaft by the non-vertical arm. In some such examples, the blade is located at one end of said non-vertical arm outside the vertical axis, and the flap is positioned between the vertical axis and said end.

In some examples disclosed herein, a vertical axis wind turbine comprising one of the example braking devices disclosed herein. Also, in some examples, a wind turbine comprising three of the example braking devices disclosed herein.

### BRIEF DESCRIPTION OF THE DRAWINGS

These aspects, as well as other aspects of the teachings disclosed herein, will appear more clearly in the detailed description of particular examples disclosed herein, with reference to the drawings of the figures, in which:

FIG. 1 shows a top view of an example vertical axis wind turbine when flaps of the example braking device teachings of this disclosure are in a nominal position;

FIG. 2 shows an example of a blade having a symmetric profile, on which lift acts due to a non-zero relative wind speed;

FIG. 3 shows a top view of an example vertical axis wind turbine when flaps of the example braking device of the teachings of this disclosure have tipped through a tipping angle with respect to their nominal position;

FIG. 4 shows an example of a flap of the example braking device before and after tipping through a tipping angle equal to about 90°;

FIG. 5 is a graph showing an example change in tipping angle of a torque limiter as a function of the applied torque;

FIG. 6 is a schematic of an example braking device with an example flap as part of an example blade;

FIG. 7 is a cross-sectional view of a portion of an example vertical axis wind turbine when the braking device is active.

The drawings of the figures are not to scale. Generally, similar elements are denoted by similar references in the figures. The presence in the drawings of reference numbers may not be considered to be limiting, even when these numbers are indicated in the claims.

### DETAILED DESCRIPTION

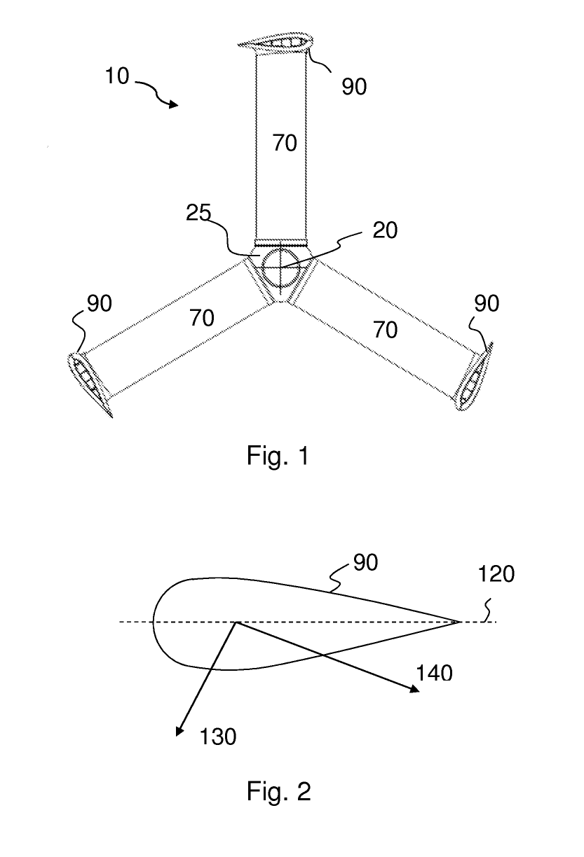

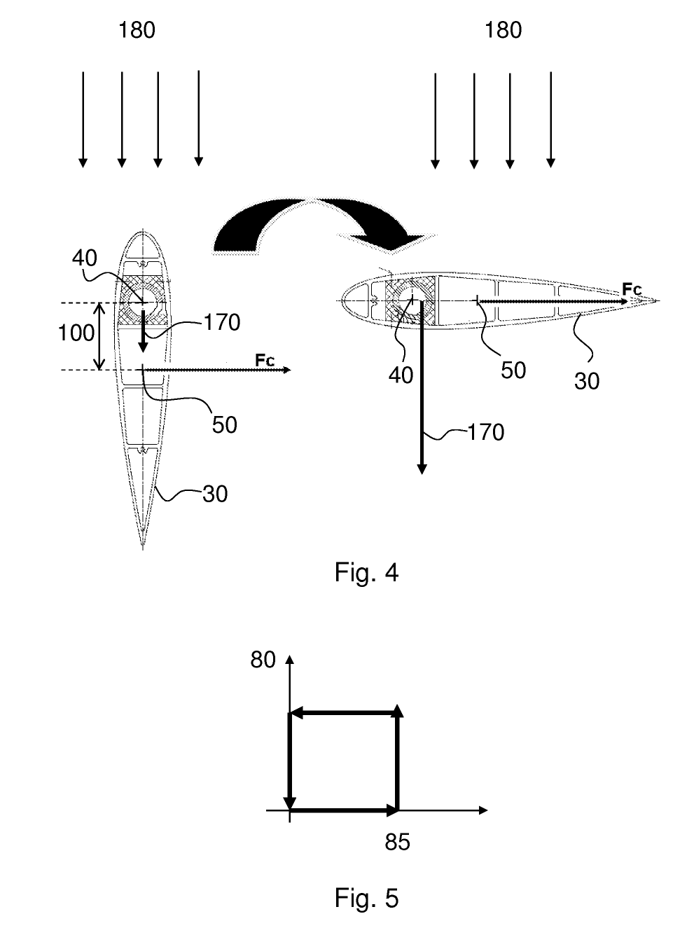

FIG. 1 shows an example wind turbine 10 having a vertical axis 20 as seen from above when an example braking device is not active. The example turbine 10 includes three blades 90 that are offset with respect to one another by 120° and that are connected to a vertical rotating shaft 25 via respective intermediary non-vertical arms 70 (or bars). In some examples, the arms 70 are horizontal. The vertical rotating shaft 25 has an axis of rotation that coincides with the vertical axis 20. When wind 180 (FIG. 4) of non-zero speed is incident on the blades 90, the blades 90 are to move in rotation about the vertical axis 20. The blades 90 can then drive a rotor of a generator in rotation, for example to produce electric power. This movement in rotation comes from the profile of the blades 90 (typically an “airplane wing” profile) and from the presence of a resulting non-zero force acting on all the blades 90. These aspects are known to those skilled in the art and are fundamental to Darrieus type vertical axis wind turbines. Knowing the various forces acting on the blades 90 makes it possible to determine the driving torque developed by a Darrieus type vertical axis wind turbine. The force developed on one blade 90 can be resolved into two components: lift 130, which acts perpendicular to a relative speed 140 of the wind 180 with respect to the blade in question, and drag, which acts parallel to and in the same sense as this relative speed 140. The relative speed 140 depends on the speed at which each blade 90 is driven as a consequence of its movement in rotation about the vertical axis 20. For a blade 90 having a symmetric profile (NACA0018 for example), the point at which the lift 130 and drag act (the aerodynamic center) is located on the chord of the profile at approximately one-quarter of the length of the chord when measured from the leading edge. FIG. 2 shows an example of a profile of a blade 90, which is symmetric, with the relative speed 140 and the lift 130 for a given wind direction. The magnitudes of the lift 130 and drag 170 forces acting on each blade 90 for a given wind speed and direction can be calculated using dimensionless lift and drag coefficients that are a function of the angle of attack of the wind and the Reynolds number in particular. These calculations are known to those skilled in the art; see for example “Wind Turbine Design With Emphasis on Darrieus Concept” by I. Paraschivoiu, Polytechnic International Press, 2002.

In the configuration shown in FIG. 1, the various blades 90 are positioned such that their movement in rotation about the vertical axis 20 induces minimum drag. In some examples, the arms 70 (or bars) have an airplane wing profile such that the drag 170 generated by the movement in rotation about the vertical axis 20 is minimal. Also, in some examples, the shape of the non-vertical arms 70 is the same as that of the blades 90. The non-vertical arms 70 need not be horizontal. In some examples, the arms 70 are oblique and, thus, not perpendicular with respect to the vertical axis 20. Various types of material can be used for producing the blades 90 and the non-vertical arms 70, some examples being: metal, wood, plastic and/or glass fibers.

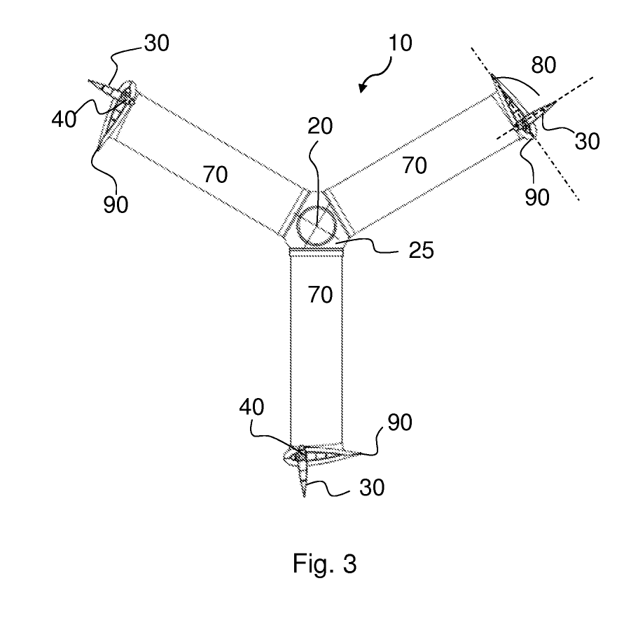

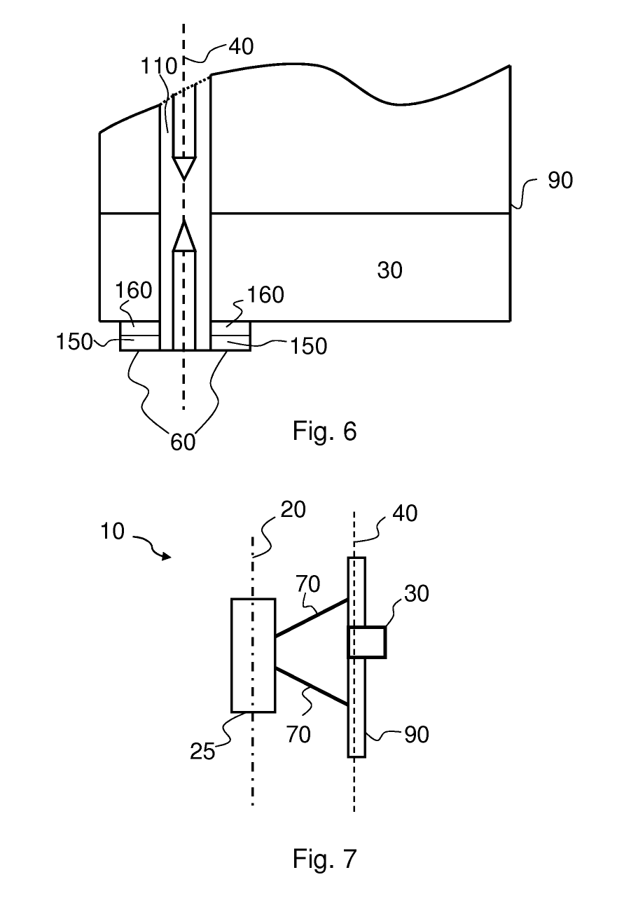

FIG. 3 shows an example wind turbine 10 having a vertical axis 20 as seen from above when the example braking device disclosed herein is active. The example braking device comprises one or more torque limiters 60 and each one of these comprises one stationary portion 150 and one portion 160 (FIG. 6) that can move with respect to the non-vertical arms 70. The flap or flaps 30 of the braking device are mechanically connected to the moving portion(s) 160 of the torque limiter(s) 60. The torque limiters 60 (FIG. 6) enable the flaps 30 to tip through a tipping angle 80 about a tipping axis 40 when a maximum rotational speed of the flaps 30 about the vertical axis 20 is reached. In the example shown in FIG. 3, the flaps 30 have tipped through a tipping angle 80 equal to 90° about the tipping axis 40; the flaps 30 are in a tipped position. Following this tipping, the drag 170 induced by the flaps 30 during their movement in rotation about the vertical axis 20 becomes substantial, making it possible to brake or even stop the movement in rotation of the blades 90 about the vertical axis 20. In the example illustrated in FIG. 3, the flaps 30 apply a braking torque with a relatively large lever arm. This lever arm is the radius of the wind turbine, which, in some examples, is generally between three and five meters. This large lever arm makes it possible to reduce the resulting force to be applied for braking the wind turbine and, thus, to reduce the loads on the braking device materials. A configuration as shown in FIG. 3 has advantages over a central braking system such as a disk brake system, for which the lever arm is smaller and loads on the materials are therefore larger.

FIG. 4 shows a flap 30 of the braking device before (left) and after (right) tipping through a tipping angle 80 for a given wind direction 180. FIG. 4 corresponds to an example corresponding to a tipping angle 80 equal to 90°. Before tipping (left part of FIG. 4), the flap 30 is in a nominal position. When the flap 30 is in rotation about the vertical axis 20, a centrifugal force \vec{F}_{c} acts at the center of gravity 50 of the flap 30. The nominal position is such that a centrifugal force \vec{F}_{c} induced by the rotation of the flap 30 about the vertical axis 20 and acting at the center of gravity 50 of the flap 30 is able to create a non-zero torque with respect to the tipping axis 40 in this nominal position. In the particular case where the vertical axis 20 and the tipping axis 40 are coplanar (the vertical axis 20 intersecting or parallel to the tipping axis 40), this means that the center of gravity 50 (also referenced by the letter G in the following) is then located outside the plane defined by these two axes. “Torque” in this context is sometimes called a moment by those skilled in the art. The torque C exerted by the centrifugal force with respect to the tipping axis 40 is given by the Equation (1):

C=(\vec{PG}×\vec{F}_{c}).\vec{u} (Eq. 1),

where P is a point on the tipping axis 40, G is the center of gravity 50 and \vec{u} is a unit vector along the tipping axis 40. Eq. 1 is a mixed product, where the symbol × represents a vector product and the symbol · represents a scalar product. The centrifugal force is proportional to the square of the rotational speed of the flap 30 about the vertical axis 20. The centrifugal force \vec{F}_{c} therefore increases when the rotational speed of the flap 30 about the vertical axis 20 increases. In some examples, the nominal position corresponds to a position inducing minimum drag 170 due to the movement in rotation of the flap 30 about the vertical axis 20. In FIG. 4, the length of the arrow representing the drag 170 increases from the nominal position (left part of FIG. 4) to the tipped position (right part of FIG. 4).

In the illustrated example, the flap 30 is mechanically connected to a moving portion 160 of a torque limiter 60 having a given disengagement torque 85. Various types of torque limiter 60 can be used for the example braking device disclosed herein. For example, the SK range, made by SNT, can be used. When a torque greater than the disengagement torque 85 is applied to a torque limiter 60, the latter allows an element, which is connected to its moving portion 160, to rotate suddenly through a given tipping angle 80. In some examples, the example torque limiter 60 disclosed herein is centered on the tipping axis 40. For the example braking device disclosed herein, the torque limiter 60 can produce one or more tipping angles 80 when the torque C exerted by the centrifugal force with respect to the tipping axis 40 (and given by Eq. 1) is greater than one or more disengagement torques 85. Indeed, the various tipped positions can be characterized by different disengagement torques 85. In some examples, the torque limiter 60 is characterized by regular tipping angles 80. Standard tipping angles 80 are every 60° but other values (30°, 90°, 120 ° for example) are possible. The example torque limiter 60 disclosed herein is, thus, a synchronous torque limiter and not a sliding torque limiter. A sliding torque limiter simply causes the flap to tip (or frees it to move in rotation) with no control over the amplitude of the ensuing tipping (the moving portion of the torque limiter goes crazy as there is no longer a resisting torque). That is not the case for the example torque limiter 60 disclosed herein, which has not only a predetermined disengagement torque but also a predetermined tipping angle 80.

The right-hand portion of FIG. 4 shows the flap 30 after disengagement of the torque limiter 60, that is once the moving portion 160 of the latter has caused the flap 30 to tip through a tipping angle 80. In this example, the tipping angle 80 is equal to 90°. It then follows hat the torque exerted by the centrifugal force \vec{F}_{c} with respect to the tipping axis 40 is zero according to Eq. 1. In this example, there is therefore no longer any risk of the torque limiter 60 subsequently disengaging. For this example, the flap 30 has an angle of incidence of 90° with respect to a peripheral speed vector of the flap 30 in rotation about the vertical axis 20; it generates maximum drag 170, the consequence of which is to apply a braking torque which will reduce the rotational speed of the flap 30, and thus of the wind turbine 10, about the vertical axis 20. In other examples corresponding to a tipping angle 80 less than 90°, a torque C exerted by \vec{F}_{c} with respect to the tipping axis 40 remains after the flap 30 has tipped with respect to its nominal position. This torque C is however less than the torque exerted before tipping as the lever arm 100 is reduced after tipping. Once the flap 30 has tipped, it is possible to return the flap 30 (typically manually) to its nominal operating position by re-engaging the torque limiter 60. Thus, in some examples, to return the flap 30 to its initial position after tipping, a torque greater than or equal to the disengagement torque 85 is manually applied in the opposite sense to the torque which produced the tipping. When the tipping angle 80 is 90°, it is possible to produce a complete rotation of the flap 30 of the braking device by four times applying a torque greater than the disengagement torque 85, this being applied each time in the same direction. A typical operation of a torque limiter 60 is illustrated in FIG. 5 which shows the tipping angle 80 of a torque limiter 60 along the ordinate, as a function of the torque to which it is subjected along the abscissa, for a complete cycle. At the start, the tipping angle 80 is zero. When the torque applied to the torque limiter 60 reaches the disengagement torque 85, the tipping angle 80 increases suddenly. From this moment, the speed of the wind turbine 10 having a vertical axis 20 typically decreases, reducing the value of the torque to which the torque limiter 60 is subjected. As the tipping angle 80 is reduced to its initial value (zero in FIG. 5), the torque limiter 60 is to be re-engaged. In some examples, the disengagement torque 85 is between 100 and 400 Nm and, in some such examples, between 265 and 300 Nm. Also, in some examples, the disengagement torque 85 is 283 Nm. In some examples, the torque limiter 60 comprises a range of adjustment for the disengagement torque 85 making it possible to change the limit rotational speed at which the flap 30 tips. This range of adjustment is, in some examples, between 220 Nm and 400 Nm. The torque limiter is, in some examples, triggered when the rotational speed of the flap 30 about the vertical axis 20 is greater than or equal to 90 revolutions per minute, and in some examples, when the rotational speed of the flap 30 is greater than 120 revolutions per minute.

FIG. 6 shows an example in which the example braking device disclosed herein has the flap 30 as a portion of a blade 90 of a wind turbine having a vertical axis 20. In the example shown in FIG. 6, the flap 30, which is a portion of the blade 90, is connected to a torque limiter 60 at a lower end of the blade 90. More precisely, the flap 30 is connected to a portion 160 of the torque limiter 60 which can move with respect to the non-vertical arm 70 (not shown in FIG. 6). The torque limiter 60 also comprises a portion 150 that is stationary with respect to this same non-vertical arm 70. Other configurations are possible. The flap 30, which is a portion of the blade 90, can thus be connected to the moving portion 160 of a torque limiter 60 at an upper end of a blade 90. In some examples, several flaps 30 are associated with a single blade 90, these flaps then constituting different bits of one and the same blade 90. These various flaps 30 can be mechanically connected to one and the same moving portion 160 of a torque limiter 60. In some examples, when two flaps 30 are associated to one and the same blade 90, the flaps 30 are each positioned at a different end (upper end and lower end) of the blade 90. In FIG. 6, the torque limiter 60 is mounted on a cylindrical tube 110 positioned around the tipping axis 40. In some examples, the cylindrical tube 110 makes it possible to attach the flap 30 to the other portion of the blade 90 via the intermediary of a sheath secured to this other portion of the blade 90. In order to guide the flap 30 in an appropriate manner, in some examples the flap is fitted with an anti-friction material. The braking power can be changed by changing the vertical extent of the flap 30. The taller the flap, the greater the braking as the drag is then greater. In an example in which the flap 30 is a portion of a blade 90 of a wind turbine 10 having a vertical axis 20, the vertical extent of the flap 30 is between 200 mm and 1 m. In some examples, the vertical extent of the flap 30 is chosen to be equal to 1/16 of that of a blade 90. Thus, in the case of an F64-10 blade (8 meters tall), the vertical extent of the flap 30 will be 500 mm. For an F16-05 blade (4 m tall), the vertical extent of the flap 30 will be 250 mm.

In another example, the flap 30 is a blade 90 of a wind turbine 10 having a vertical axis. Thus, in this case, the braking is provided by an entire blade 90 tipping.

According to another example, the teachings of this disclosure provide an example wind turbine 10 having a vertical axis 20, in which the turbine 10 comprises an example braking device as described hereinabove. In some examples, the wind turbine 10 having a vertical axis 20 comprises blades 90 that are vertical and straight; such a wind turbine 10 is sometimes referred to by those skilled in the art as an “H-rotor Darrieus turbine”. FIG. 7 is a cross-sectional view through a portion of a wind turbine 10 having a vertical axis 20. In the example shown in FIG. 7, the braking device is active and the flap 30 has been tipped. In the example shown in FIG. 7, the non-vertical arms 70 are oblique and the flap 30 is located on the blade 90. In this example, the flap 30 is in fact located halfway up the blade 90, between attachment points securing this blade 90 to the two non-vertical arms 70. In another example, the flaps 30 are located on the non-vertical arms 70, between the vertical axis 20 and the ends of the arms to which the blades 90 are mechanically connected. In some examples, in which the wind turbine 10 comprises only a single blade 90, the blade is counterbalanced such that the blade 90 rotates smoothly about the vertical axis 20. In some examples, the wind turbine comprises several blades 90, for example three, and the wind turbine comprises an equal number of flaps 30, three in this example.

The teachings of the present disclosure have been described in relation to specific examples that are purely illustrative and should not be seen as limiting. In a general manner, the teachings of the present disclosure is not restricted to the examples illustrated and/or described hereinabove. In particular, the teachings also relate to combinations of the technical features of the examples disclosed above. Use of the verbs “comprise”, “include”, or any other variant, as well as their conjugated forms, can in no way exclude the presence of elements other than those mentioned. The use of the indefinite article “a”, or the definite article “the”, to introduce an element does not exclude the presence of a plurality of these elements. The reference numbers in the claims do not restrict their scope.

In summary, the examples disclosed herein include an example braking device for a wind turbine having a vertical axis, comprising a flap able to tip about a tipping axis, said flap having a center of gravity positioned outside the tipping axis. The example braking device disclosed herein is characterized in that the braking device further comprises a torque limiter having a disengagement torque, in that the flap is mounted on said torque limiter, and in that said torque limiter is able to allow said flap to tip through a tipping angle about said tipping axis for a rotational speed of said flap about said vertical axis which induces a torque at the torque limiter greater than or equal to the disengagement torque.

Although certain example methods and apparatus have been disclosed herein, the scope of coverage of this patent is not limited thereto. On the contrary, this patent covers all methods, apparatus and articles of manufacture fairly falling within the scope of the appended claims either literally or under the doctrine of equivalents.

1. An apparatus comprising:
a flap of a braking device for a wind turbine, the flap coupled by a non-vertical arm to a vertical rotating shaft having an axis of rotation that coincides with a vertical axis of the wind turbine, wherein the flap is to rotate about the vertical axis in a nominal position and to tip about a non-horizontal tipping axis, wherein the flap has a center of gravity positioned outside the tipping axis, the nominal position being such that a centrifugal force induced by the rotation of the flap about the vertical axis and acting at the center of gravity is able to create a non-zero torque with respect to the tipping axis in the nominal position; and
a torque limiter having a disengagement torque, one stationary portion and one moving portion that is able to move with respect to the non-vertical arm, wherein the flap is coupled to the moving portion of the torque limiter, and wherein the moving portion of the torque limiter is to allow the flap to tip from the nominal position through a tipping angle about the tipping axis when a threshold rotational speed of the flap about the vertical axis is reached, a centrifugal force acting at the center of gravity of the flap in the nominal position then inducing a torque at the torque limiter that is greater than the disengagement torque.

2. The apparatus of claim 1, wherein the tipping axis is parallel to the vertical axis.

3. The apparatus of claim 1, wherein the wind turbine comprises a blade coupled to the vertical rotating shaft by the non-vertical arm and wherein the flap comprises a portion of the one blade.

4. The apparatus of claim 3, wherein the portion of the blade is coupled to the moving portion of the torque limiter at one end of the blade.

5. The apparatus of claim 4, wherein the end corresponds to a lower end of the blade.

6. The apparatus of claim 1, wherein the wind turbine comprises a blade coupled to the vertical rotating shaft by the non-vertical arm and wherein the flap comprises the blade.

7. The apparatus of claim 1, wherein the tipping angle is about 90°.

8. The apparatus of claim 1, wherein the wind turbine comprises a blade coupled to the vertical rotating shaft by the non-vertical arm, and wherein the blade is disposed at one end of the non-vertical arm outside the vertical axis, wherein the flap is positioned between the vertical axis and the end.

9. A wind turbine comprising:
a vertical axis; and
a first braking device comprising:
a flap coupled by a non-vertical arm to a vertical rotating shaft having an axis of rotation that coincides with the vertical axis, wherein the flap is to rotate about the vertical axis in a nominal position and to tip about a non-horizontal tipping axis, wherein the flap has a center of gravity positioned outside the tipping axis, the nominal position being such that a centrifugal force induced by the rotation of the flap about the vertical axis and acting at the center of gravity is able to create a non-zero torque with respect to the tipping axis in the nominal position; and
a torque limiter having a disengagement torque, one stationary portion and one moving portion that is able to move with respect to the non-vertical arm,
wherein the flap is coupled to the moving portion of the torque limiter, and
wherein the moving portion of the torque limiter is to allow the flap to tip from the nominal position through a tipping angle about the tipping axis when a threshold rotational speed of the flap about the vertical axis is reached, a centrifugal force acting at the center of gravity of the flap in the nominal position then inducing a torque at the torque limiter that is greater than the disengagement torque.

10. The wind turbine as defined in claim 9, further comprising a second braking device and a third braking device.
